(19) United States
(12) Patent Application Publication
(10) Pub. No.: US 2016/0034919 A1
(43) Pub. Date: Feb. 4, 2016

(54) COLLECTION AND AGGREGATION OF LARGE VOLUME OF METRICS

(71) Applicant: AppDynamics, Inc., San Francisco, CA (US)

(72) Inventor: Gautam Borah, Fremont, CA (US)

(21) Appl. No.: 14/448,977

(22) Filed: Jul. 31, 2014

(51) Int. Cl. G06Q 30/02

(52) U.S. Cl. CPC G06Q 30/0201

(57) ABSTRACT

A system processes a large volume of real time hierarchical system metrics using distributed computing by stateless processes. The metrics processing system receives different types of hierarchical metrics coming from different sources and then aggregates the metrics by their hierarchy. The system is on-demand, cloud based, multitenant and highly available. The system makes the aggregated metrics available for reporting and policy triggers in real time. The metrics aggregation and roll up method involves two different classes of stateless java programs that work in tandem to receive, aggregate and roll up the incoming metrics. The method also involves a persistence store to save incoming and aggregated metrics. The method uses a quorum to communicate between these processes.

### BACKGROUND OF THE INVENTION

The World Wide Web has expanded to make various services available to the consumer as online web application. A multi tiered web application is comprises of several internal or external services working together to provide a business solution. These services are distributed over several machines or nodes, creating an n-tiered, clustered on-demand business application. The performance of a business application is determined by the execution time of a business transaction; a business transaction is an operation that completes a business task for end users of the application. A business transaction in an n-tiered web application may start at one service and complete in another service involving several different server machines or nodes. For Example, reserving a flight ticket involves a typical business transaction “checkout” which involves shopping-cart management, calling invoicing and billing system etc., involving several services hosted by the application on multiple server machines or nodes. It is essential to monitor and measure a business application to provide insight regarding bottlenecks in communication, communication failures and other information regarding performance of the services that provide the business application.

A business application is monitored by collecting several metrics from each server machine or node in the system. The collected metrics are aggregated by service or tier level and then again aggregated by the entire application level. The metric processing involves aggregation of hierarchical metrics by several levels for an n-tier business application. In a large business application environment hundreds and thousands of server machines or nodes create multiple services or tiers, each of these nodes generate millions of metrics per minute.

There is a need for a system that would be able to process millions of metrics per minute in real time and also aggregate the metrics to their tier and application level. The aggregated metrics could be used for monitoring reports, policy triggers etc. in real time.

### SUMMARY OF THE CLAIMED INVENTION

The present technology processes a large volume of real time hierarchical system metrics using distributed computing by stateless processes. The metrics processing system receives different types of hierarchical metrics coming from different sources and then aggregates the metrics by their hierarchy. The system is on-demand, cloud based, multi-tenant and highly available. The system makes the aggregated metrics available for reporting and policy triggers in real time.

The metrics aggregation and roll up method involves two different classes of stateless java programs, collectors and aggregators, that work in tandem to receive, aggregate and roll up the incoming metrics. The method also involves a persistence store to save incoming and aggregated metrics. The method uses a quorum to communicate between these processes.

An embodiment may include a method for processing metrics. A payload is received which includes sets of data. A hash from each set of data is then generated. Each data set may be transmitted to one of a plurality of aggregators based on the hash. Received metrics are then aggregated by each of a plurality of aggregators.

An embodiment may include a system for monitoring a business transaction. The system may include a processor, a memory and one or more modules stored in memory and executable by the processor. When executed, the one or more modules may receive a payload which includes sets of data, generate a hash from each set of data, transmit each data set to one of a plurality of aggregators based on the hash, and aggregate received metrics by each of a plurality of aggregators.

### BRIEF DESCRIPTION OF THE DRAWINGS

FIG. 1 is a block diagram of a system for aggregating data.

FIG. 2 is a block diagram of a collector and aggregator.

FIG. 3 is a method for processing metrics.

FIG. 4 is a method for checking previous payload processing.

FIG. 5 is a method for adding a new node to an aggregator cluster.

FIG. 6 is a method for retrieving data for a metric type.

FIG. 7 is a block diagram of a system for implementing the present technology.

### DETAILED DESCRIPTION

The present technology processes a large volume of real time hierarchical system metrics using distributed computing by stateless processes. The metrics processing system receives different types of hierarchical metrics coming from different sources and then aggregates the metrics by their hierarchy. The system is on-demand, cloud based, multi-tenant and highly available. The system makes the aggregated metrics available for reporting and policy triggers in real time.

The metrics aggregation and roll up method involves two different classes of stateless java programs that work in tandem to receive, aggregate and roll up the incoming metrics. The method also involves a persistence store to save incoming and aggregated metrics. The method uses a quorum to communicate between these processes.

The method involves a collector process and an aggregators process. The first class of java processes, collectors, are stateless java programs. Multiple numbers of these collector programs could be instantiated depending on the incoming metrics load. The collector processes may receive the incoming metric traffic through a load balancer mechanism. Once the metrics are received, collector processes save the metrics in a persistence store and then based on a universal hashing algorithm route metrics to specific aggregator nodes.

The second class of stateless java processes, aggregators, are arranged in a consistent hash ring using the same universal hash function. This may ensure a metric will be routed to the same aggregator node from any collector node.

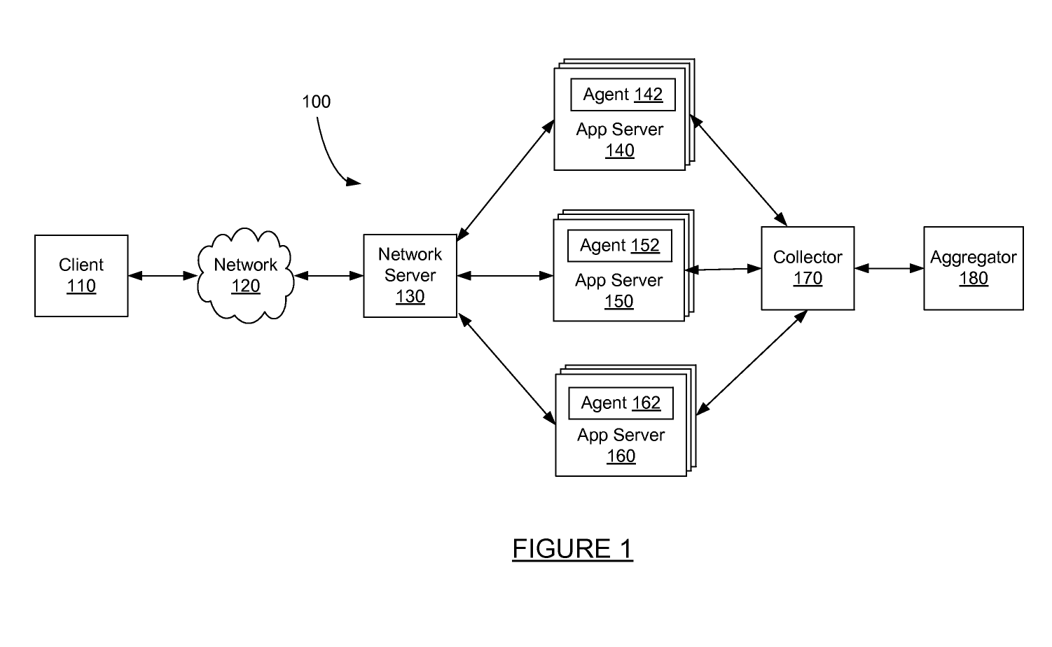

FIG. 1 is a block diagram of a system for aggregating data. The system of FIG. 1 includes client 110, network server 130, application servers 140, 150 and 160, collector 170 and aggregator 180. Client 110 may send requests to and receive responses from network server 130 over network 120. In some embodiments, network server 130 may receive a request, process a portion of the request and send portions of the request to one or more application servers 140-150. Application server 140 includes agent 142. Agent 142 may execute on application server 140 and monitor one or more functions, programs, modules, applications, or other code on application server 140. Agent 142 may transmit data associated with the monitored code to a collector 170. Application servers 150 and 160 include agents 152 and 162, respectively, and also transmit data to collector 170.

Collector 170 may receive metric data and provide the metric data to one or more aggregators 180. Collector 170 may include one or more collector machines, each of which using a logic to transmit metric data to an aggregator 180 for aggregation. Aggregator 180 aggregates data and provides the data to a cache for reports to external machines. The aggregators may operation in a ring, receiving metric data according to logic that routes the data to a specific aggregator. Each aggregator may, in some instances, register itself with a presence server. If an aggregator fails or goes down, a new aggregator may be added. Aggregator fail over is discussed in more detail below.

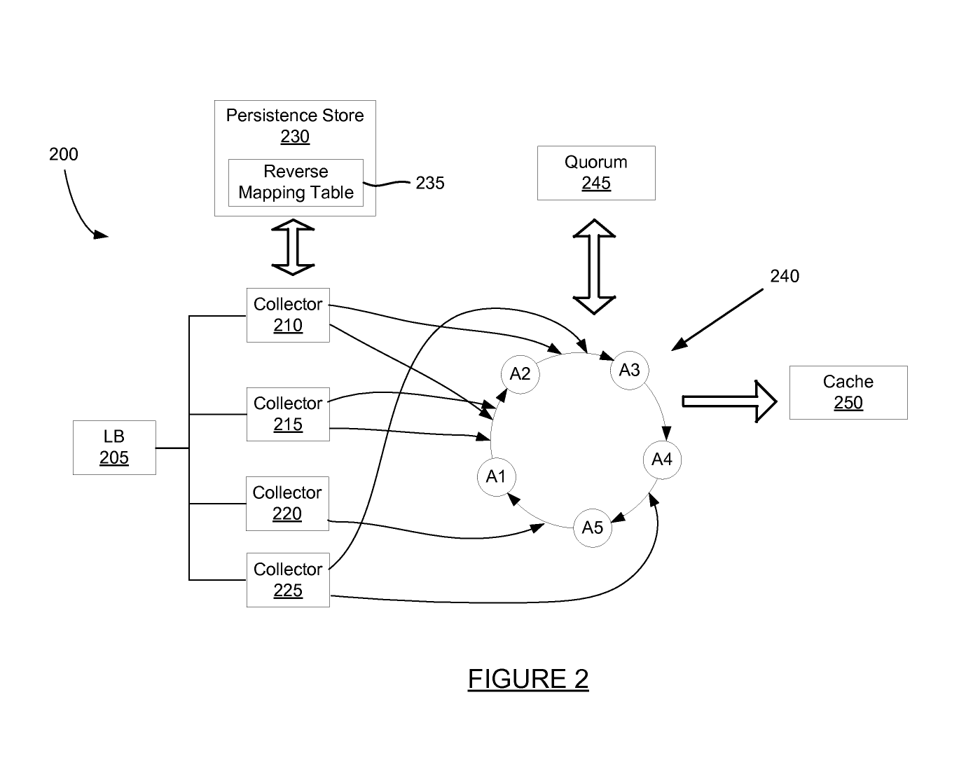

FIG. 2 is a block diagram of a collector and aggregator. The system of FIG. 2 includes load balancer 205, collectors 210, 215, 220 and 225, a persistence store 235, and aggregators 240 (A1-A5). The system of FIG. 2 also includes quorum 245 and cache 250. Agents on application servers may transmit metric data to collectors 210-225 through load balance machine 205. In some embodiments, the metrics are sent from the agent to a collector in a table format for example once per minute.

The collectors receive the metrics and use logic to route the metrics to aggregators. The logic may include determining a value based on information associated with the metric, such as a metric identifier. In some instances, the logic may include performing a hash on the metric ID. The metric may be forwarded to the aggregator based on the outcome of the hash of the metric ID. The same hash is used by each and every collector to ensure that the same metrics are provided to the same aggregator.

The collectors may each register with quorum 245 when they start up. In this manner, the quorum may determine when one or more collectors is not performing well and/or fails to register.

A persistence store stores metric data provided from the collectors to the aggregators. A reverse mapping table may be used to associate data with a metric such that when an aggregator fails, the reverse mapping table may be used to replenish a new aggregator with data associated with the metrics that it will receive.

Each aggregator may receive one or more metric types, for example two or three metrics. The metric information may include a sum, count, minimum, and maximum value for the particular metric. An aggregator may receive metrics having a range of hash values. The same metric type will have the same hash value and be routed to the same aggregator. An aggregator may become a coordinator. A coordinator may check quorum data and confirm persistence was successful.

Once aggregated, the aggregated data is provided to a cache 250. Aggregated metric data may be stored in cache 250 for a period of time and may eventually be flushed out. For example, data may be stored in cache 250 for a period of eight hours. After this period of time, the data may be overwritten with additional data.

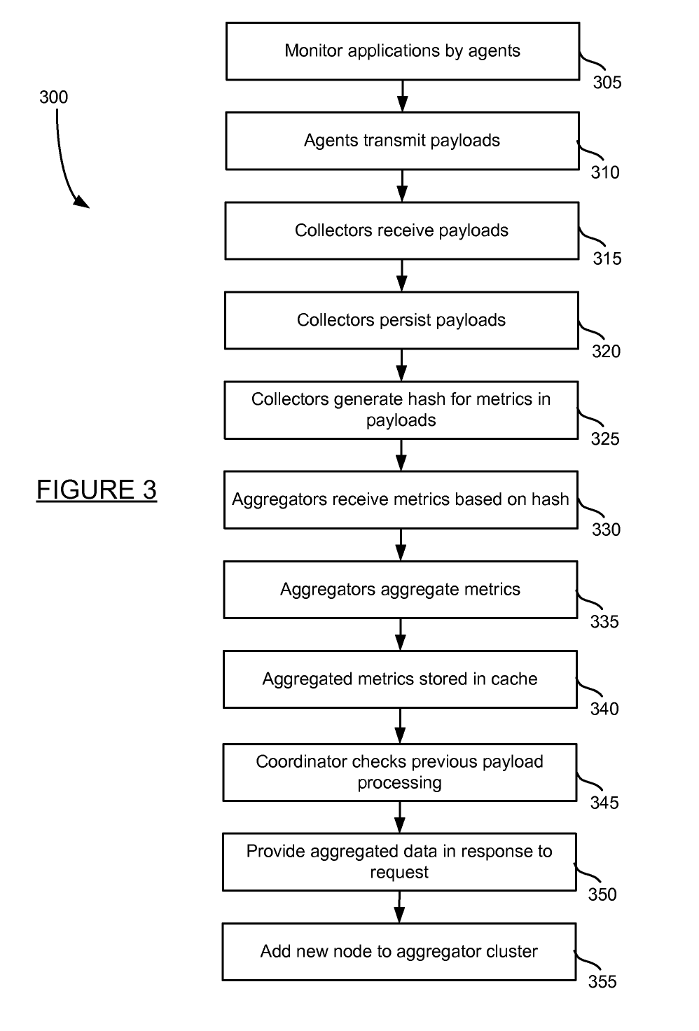

FIG. 3 illustrates a method for processing metrics. First, applications are monitored by agents at step 305. The agents may collect information from applications and generate metric data. The agents may then transmit payloads to one or more collectors at step 310. The payloads may include metric information associated with the applications and other code being monitored by the particular agent. The payloads may be sent periodically from a plurality of agents to one or more collectors.

One or more collectors may receive the payloads at step 315. In some embodiments, a collector may receive an entire payload from an agent. The collectors persist the payload at step 320. To persist the payload, a collector may transmit the payload to a persistence store 230.

A collector may generate a hash for metric data within the payload at step 325. For example, for each metric, the collector may perform a hash on the metric type to determine a hash value. The hash same hash is performed on each metric by each of the one or more collectors. The metrics may then be transmitted by the collectors to a particular aggregator based on the hash value. Forwarding metric data to a particular aggregator of a plurality of aggregator is an example of the consistent logic that may be used to route metric data to a number of aggregators. Other logic to process the metric data may be used as well as long as it is the same logic applied to each and every metric.

The aggregators receive the metrics based on the hash value at step 330. For example, each aggregator may receive metrics having a particular range of hash values, the next aggregator may receive metrics having a neighboring range of hash values, and so on until a ring is formed by the aggregators to handle all possible hash values.

The aggregators then aggregate the metrics at step 335. The metrics may be aggregated to determine the total number of metrics, a maximum, a minimum, and average value of the metric. The aggregated metrics may then be stored in a cache at step 340. A controller or other entity may retrieve the aggregated metrics from the cache for a limited period of time.

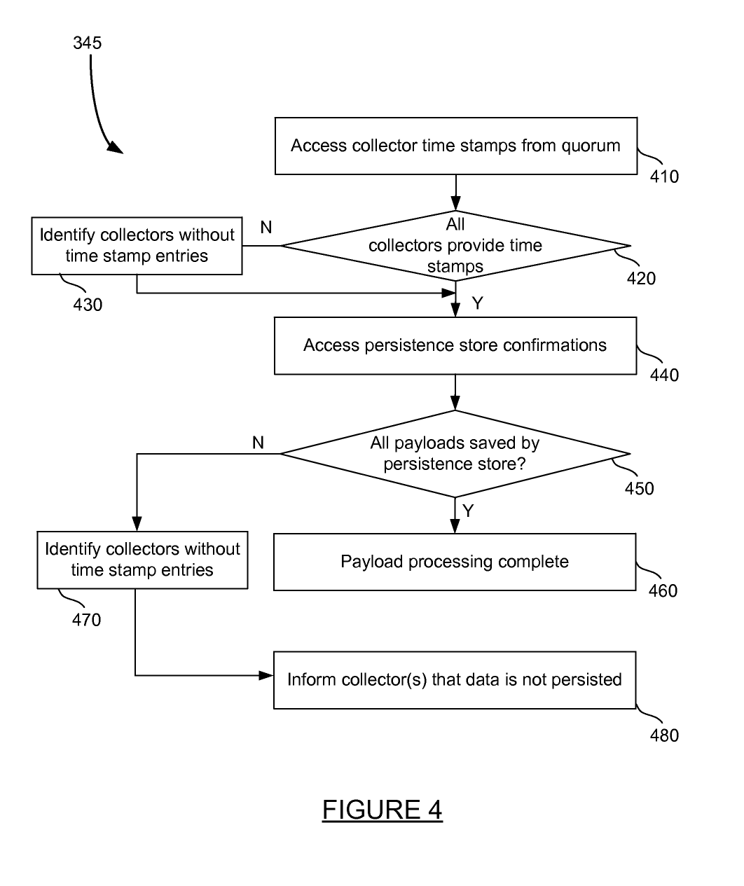

The coordinator of the collectors or aggregators may check a previous payload processing at step 345. The coordinator may be a selected collector that performs tasks including confirmation of successful processing of previous payloads. In some embodiments, the coordinator checks the previous payload processing to determine if the previous batch of data was successfully provided to the aggregators, for example by checking time stamps for each collector's persistence of data for a particular time window. Checking a previous payload processing by a coordinator is discussed in more detail with respect to the method of FIG. 4.

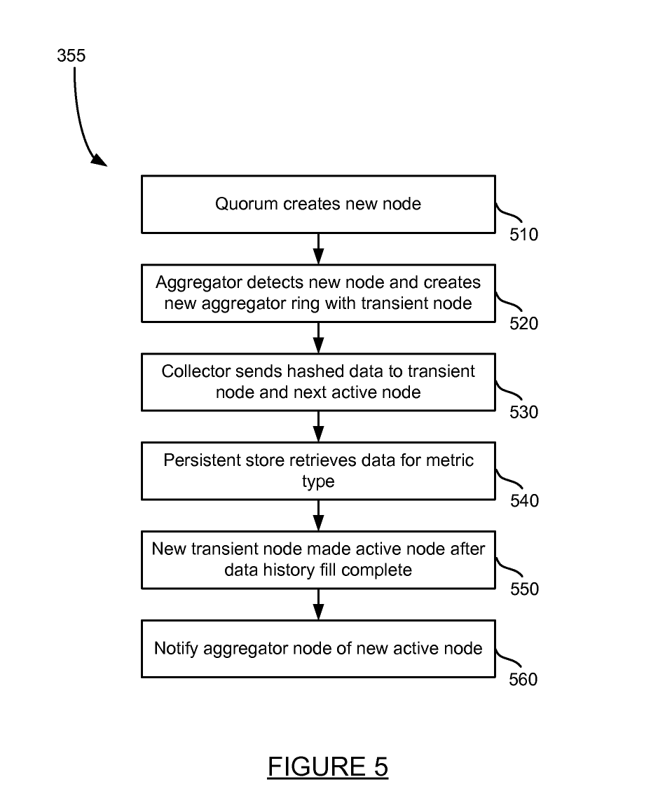

The aggregated data may be provided in response to a request at step 350. Occasionally, as aggregated data is provided to a cache, an aggregator may fail or behave poorly. In this case, the failed aggregator node may be replaced with a new aggregator. A new aggregator node may be added to an aggregator cluster at step 355. A new node may be added to an aggregator cluster if one of the aggregators fails or goes down. Adding a new node to an aggregator cluster is discussed in more detail with respect to the method of FIG. 5.

FIG. 4 provides a method for checking previous payload processing. First, collector time stamps are accessed from a quorum at step 410. A determination is then made as to whether all collectors have provided the time stamp at step 420. The time stamps collected may be compared to a list of collectors that have checked in with a presence service, such as for example a presence service provided by the persistence store, quorum, or other machine. If not all collectors have provided a time stamp, the collectors without time stamp entries are identified at step 430 and the method continues to step 440. If all collectors have provided a time stamp, the persistence store confirmations are accessed at step 440. A determination is then made as to whether all payloads have been saved by the persistence store at step 450. If all payloads have been saved, the payload processing is complete at step 460. If all payloads have not been saved, collectors are identified that do not have time stamp entries at step 470 and collectors for which time stamp entries were not found are informed that data is not persisted at step 480. In response to being informed that their data was not persisted, in some instances, a collector may provide the data that was not persisted to the persistence store if the data is still available.

As discussed earlier, an aggregator in the ring of aggregators may occasionally fail or demand may require another aggregator be added. When this occurs, the present system may add a new aggregator to the aggregator ring. FIG. 5 is a method for adding a new aggregator node to an aggregator cluster. First, a quorum creates a new node at step 510. An aggregator then detects the new node and creates a new aggregator ring with a transient node at step 520. One or more collectors send hash data to the transient node and to the next active aggregator node at step 530.

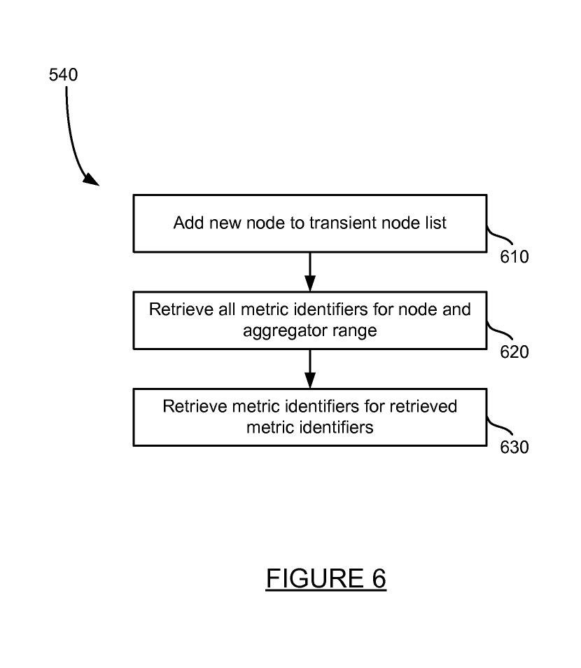

A persistence store may then retrieves the data for a metric type at step 540. The retrieved data may be used to populate the historic metric data for each metric being handled (i.e., routed to the particular transient node). Retrieving data for a metric type is discussed in more detail with respect to the method of FIG. 6.

The new transient node is made an active node after the data history fill (population of historic metric data) is complete at step 550. An aggregator node is notified of the new active node at step 560.

FIG. 6 is a method for retrieving data for a metric type. First, a new node is added to the transient node list at step 610. All metric identifiers for the node and aggregator range are then retrieved at step 620. This data may be retrieved from the persistence store. Metric data is then retrieved for the retrieved metric identifiers at step 630.

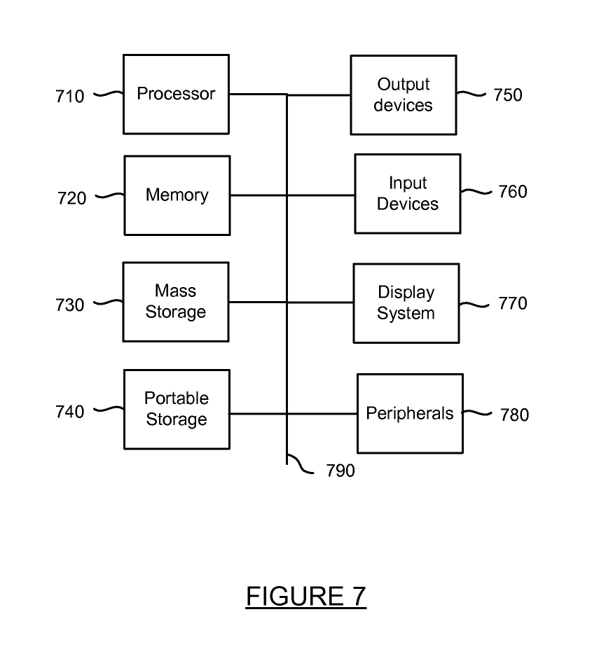

FIG. 7 is a block diagram of a computer system for implementing the present technology. System 700 of FIG. 7 may be implemented in the contexts of the likes of client 110, network server 130, application servers 140-160, collectors 170 and aggregators 180. A system similar to that in FIG. 7 may be used to implement a mobile device, such as a smart phone that provides client 110, but may include additional components such as an antenna, additional microphones, and other components typically found in mobile devices such as a smart phone or tablet computer.

The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

When implementing a mobile device such as smart phone or tablet computer, the computer system 700 of FIG. 7 may include one or more antennas, radios, and other circuitry for communicating over wireless signals, such as for example communication using Wi-Fi, cellular, or other wireless signals.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for processing metrics, comprising:
receiving a payload which includes sets of data;
generating a hash from each set of data;
transmitting each data set to one of a plurality of aggregators based on the hash; and
aggregating received metrics by each of a plurality of aggregators.

2. The method of claim 1, wherein each of the plurality of aggregators receive metrics associated with a particular hash value.

3. The method of claim 1, wherein the hash is generated from a metric identifier.

4. The method of claim 1, wherein the same hash function is applied by a plurality of collectors.

5. The method of claim 1, further comprising storing the data set at a remote store by each of one or more collectors, wherein each data set is received by a collector.

6. The method of claim 5, further comprising analyzing previous payload processing by a selected collector of the plurality of collectors.

7. The method of claim 1, further comprising providing the aggregated data to a cache.

8. The method of claim 1, further comprising:
detecting that an aggregator has failed; and
adding an aggregator to the plurality of aggregators.

9. The method of claim 8, further comprising retrieving historic metric processing data for metrics associated with the added aggregator.

10. The method of claim 8, further comprising:
transmitting selected metric data to the added aggregator; and
transmitting the selected metric data to the a second aggregator of the plurality of aggregators.

11. A non-transitory computer readable storage medium having embodied thereon a program, the program being executable by a processor to perform a method for processing metrics, the method comprising:
receiving a payload which includes sets of data;
generating a hash from each set of data;
transmitting each data set to one of a plurality of aggregators based on the hash; and
aggregating received metrics by each of a plurality of aggregators.

12. A system for processing metrics, comprising:
a processor;
a memory; and
one or more modules stored in memory and executable by a processor to receive a payload which includes sets of data, generate a hash from each set of data, transmit each data set to one of a plurality of aggregators based on the hash, and aggregate received metrics by each of a plurality of aggregators.
